(19) United States
(12) Patent Application Publication
(10) Pub. No.: US 2024/0358100 A1
(43) Pub. Date: Oct. 31, 2024

(54) MASK AND METHOD FOR PRODUCING MASKS

(71) Applicant: APPCELL, BEAUCOUZE (FR)

(72) Inventors: Matthieu BILLIARD, Béhuard (FR); Jean-Pierre BILLIARD, Angers (FR); Denis MÉNORET, Saint Martin du Fouilloux (FR); Hubert CHEVALIER, Les Garennes sur Loire (FR); Frédéric JUNG, Angers (FR)

(21) Appl. No.: 18/580,665

(22) PCT Filed: Jul. 7, 2022
(86) PCT No.: PCT/EP2022/069007

§ 371 Date: Jan. 19, 2024

(30) Foreign Application Priority Data
Jul. 22, 2021 (FR) FR2107970

(51) Int. Cl. A41D 13/11; B01D 39/16

(52) U.S. Cl. CPC A41D 13/113; A41D 13/1161; B01D 39/1623; B01D 2239/0672

(57) ABSTRACT

A facemask manufacturing process is described. A first and a second assembly of strips are provided superposed one on the other, each of the first and the second assembly of strips comprising a first strip of filtering material, a second strip of filtering material and an elastic strip interposed between the first strip of filtering material and the second strip of filtering material. Then the first and second assemblies of strips are cut in order to form, in a top-to-tail position, a first facemask and a second facemask respectively having a median line corresponding to the first weld line and to the second weld line and orifices intended for receiving a user's ears.

### TECHNICAL FIELD

The invention relates to the field of protective facemasks and the manufacture of facemasks.

Such a protective facemask aims to protect its wearer against the inhalation of pathogens, such as viruses or bacteria, dust or noxious gases, and/or to protect third parties from pathogens liable to be exhaled by its wearer.

### TECHNOLOGICAL BACKGROUND

Facemask manufacturing processes are known from the prior art. Document US2008035153 discloses, for example, a process for manufacturing a roll of facemasks, in which one or more pieces of fabric are superposed and then fixed in order to preform part of the facemask. The facemask is subsequently precut and then wound up in order to form a roll. However, this type of process causes a significant loss of material, mainly at the spaces between two adjacent facemasks. Moreover, such a facemask manufacturing process does not make it possible to adapt the materials used depending on the zones of the facemask.

There is therefore a real need to produce protective facemasks simply, in large quantities and at low cost, notably in the context of a large-scale health crisis.

### SUMMARY

The invention is based on the idea of proposing a facemask manufacturing process which is simple to implement, inexpensive and allows significant production rates.

A certain aspect of the invention relates to a facemask manufacturing process which is reliable and repeatable.

A certain aspect of the invention relates to a facemask manufacturing process which makes it possible to reduce the residual waste of materials used during the manufacture of facemasks.

The invention is also based on the idea of proposing a facemask which is optimized for the user, i.e. the facemask remains in position and covers the nose and mouth when in a use position on the face. Moreover, the facemask is comfortable for the user, i.e. it does not excessively pull on the user's ears and does not irritate the area behind the ears.

According to one embodiment, the invention provides a facemask manufacturing process comprising:
providing a first and a second assembly of strips superposed one on the other, the first assembly of strips comprising a first strip of filtering material, a second strip of filtering material and a first elastic strip interposed between the first strip of filtering material and the second strip of filtering material; the second assembly of strips comprising a third strip of filtering material, a fourth strip of filtering material and a second elastic strip interposed between the third strip of filtering material and the fourth strip of filtering material, the first strip of filtering material, the second strip of filtering material and the first elastic strip being superposed on the fourth strip of filtering material, the third strip of filtering material and the second elastic strip, respectively; then
fixing the first strip of filtering material to the fourth strip of filtering material along a first weld line;
fixing the second strip of filtering material to the third strip of filtering material along a second weld line; and then
a step of cutting the first and second assemblies of strips in order to form, in a top-to-tail position, a first facemask and a second facemask respectively having a median line corresponding to the first weld line and to the second weld line and orifices intended for receiving the user's ears.

By virtue of these features, the facemasks are manufactured in one piece, and a subsequent step of adding elastic threads intended to receive the users ears is not necessary. Moreover, cutting in a top-to-tail position makes it possible to limit wastage of material, thus limiting the waste generated by the facemask manufacturing process.

According to some embodiments, the first and the second assembly of strips superposed one on the other are formed from an assembly of five strips comprising the first strip of filtering material, a central strip of filtering material that is intended to form the second strip of filtering material and the third strip of filtering material, the fourth strip of filtering material, the first elastic strip interposed between the first strip of filtering material and the central strip of filtering material, and the second elastic strip interposed between the fourth strip of filtering material and the central strip of filtering material, wherein the assembly of five strips is folded along the center of the central strip of filtering material in order to form said second strip of filtering material and said third strip of filtering material and also the superposed first assembly of strips and second assembly of strips.

By virtue of these features, the facemask manufacturing process is easily industrializable. This is because the folding at the central strip makes it possible to superpose the first and the second assembly of strips one on the other more precisely, reliably and reproducibly.

According to one embodiment, the central strip of filtering material has a width at least twice that of the first strip of filtering material.

According to one embodiment, the first and the second assembly of strips superposed one on the other are formed from two separate assemblies of strips, the first assembly of strips being respectively formed from the first strip of filtering material, the second strip of filtering material, and the first elastic strip interposed between the first strip of filtering material and the second strip of filtering material, wherein the first strip of filtering material and the second strip of filtering material are fixed on either side of the first elastic strip in order to form said first assembly of strips, and the second assembly of strips being respectively formed from the third strip of filtering material, the fourth strip of filtering material, and the second elastic strip interposed between the third strip of filtering material and the fourth strip of filtering material, wherein the third strip of filtering material and the fourth strip of filtering material are fixed on either side of the second elastic strip in order to form said second assembly of strips.

According to one embodiment, at least one strip selected from the first strip of filtering material, the second strip of filtering material, the third strip of filtering material and the fourth strip of filtering material has at least two superposed layers, preferably three superposed layers. That is, said at least one strip has, for example, two, three, four or five superposed layers.

According to one embodiment, the first strip of filtering material, the second strip of filtering material, the third strip of filtering material and the fourth strip of filtering material have at least one layer made of a nonwoven material, which is preferably selected from polyester, polypropylene, viscose, polyethylene and polyamide. The nonwoven material is, for example, the result of dry-type, melt-type or wet-type production.

According to one embodiment, the at least two superposed layers are made up of identical or different materials.

According to one embodiment, the at least two superposed layers have an identical or different thickness.

By virtue of these features, it is possible to obtain a wide range of facemasks meeting multiple technical criteria or complying with different standards, notably alternative facemasks of category 1 and category 2, respiratory protection facemasks of the FFP1 type that filter at least 80% of aerosol particles with a mean size of 0.6 μm, of the FFP2 type that filter at least 94% of aerosol particles with a mean size of 0.6 μm, of the FFP3 type that filter at least 99% of aerosol particles with a mean size of 0.6 μm, in accordance with the NF EN 149 standard, surgical facemasks of the I type with a bacterial filtration efficiency of >95% for aerosol particles with a mean size of 3 μm, of the II type with a bacterial filtration efficiency of >98% for aerosol particles with a mean size of 3 μm, and of the IIR type having a bacterial filtration efficiency of >98% for aerosol particles with a mean size of 3 μm and having splash resistance, in accordance with the NF EN 14683 and NF EN 14683+AC standards. It is also possible to obtain facemasks in accordance with the standards of various countries, for example the N95/R95/P95, N99/R99/P99, N100/R100/P100 standards of the “National Institute for Occupational Safety and Health” (NIOSH).

According to one embodiment, at least one of the at least two superposed layers contains an antibacterial agent and/or an antiviral agent.

According to one embodiment, a connecting step is performed upstream of the cutting of the first and second assemblies of strips in order to fix the at least two superposed layers to one another and to preform, via the connecting zones, both a first lateral part and a second lateral part of the first facemask and part of the orifices of the second facemask that are intended to receive the user's ears.

By virtue of these features, the superposed layers are held together.

According to one embodiment, the connecting step is performed by welding or by embossing. The connecting step is preferably performed by ultrasonic welding. Ultrasonic welding enables rapid, precise and economical assembly, with no addition of material and without using additional adhesives. Moreover, the connecting zones obtained are robust.

According to one embodiment, the connecting step is performed upstream of the folding step.

According to one embodiment, the connecting step is performed upstream of the superposition of the first and the second assembly of strips.

By virtue of these features, the at least two superposed layers are connected to one another without running the risk of also connecting the strips that are superposed on one another.

According to one embodiment, the first elastic strip and the second elastic strip have an identical width.

According to one embodiment, the first elastic strip and the second elastic strip comprise an elastomer material.

According to one embodiment, the first elastic strip and the second elastic strip each comprise two plies of nonwoven material which sandwich the elastomer material. The two plies of nonwoven material exhibit elasticity only in a direction perpendicular to the longitudinal direction of the first and second elastic strips. According to one embodiment, the two plies of nonwoven material comprise undulations parallel to the longitudinal direction in order that the two plies of nonwoven material allow the elastic deformation of the first elastic strip and the second elastic strip solely in a direction perpendicular to the longitudinal direction. According to one embodiment, the two plies of nonwoven materials are either non-extensible nonwoven materials or nonwoven materials that can be stretched in one direction. In the case of non-extensible nonwovens, to give the first and second elastic strips elastic capabilities, it is necessary to “activate” them by partially breaking the fibers or at least by reducing the cohesion along the direction that is to be made extensible. By way of example, elastic strips as described in document FR2893036 might be used.

According to one embodiment, the first elastic strip and the second elastic strip comprise a material which is different than the first strip of filtering material, the second strip of filtering material, the third strip of filtering material and the fourth strip of filtering material.

According to one embodiment, a roll of filtering material provides a main strip of filtering material having a longitudinal direction, and wherein the first strip of filtering material, the central strip of filtering material and the fourth strip of filtering material are cut out of the main strip of filtering material via a step of cutting along the longitudinal direction of the roll of filtering material.

According to one embodiment, a roll of elastic material provides a main strip of elastic material having a longitudinal direction, and wherein the first elastic strip and the second elastic strip are cut out of the main strip of elastic material via a step of cutting along the longitudinal direction of said main strip of elastic material.

According to one embodiment, the first strip of filtering material and the second strip of filtering material are fixed on either side of the first elastic strip by welding, for example by ultrasonic welding.

According to one embodiment, the third strip of filtering material and the fourth strip of filtering material are fixed on either side of the second elastic strip by welding, for example by ultrasonic welding.

According to one embodiment, the fixing of the first strip of filtering material to the fourth strip of filtering material along the first weld line, and/or the fixing of the second strip of filtering material to the third strip of filtering material along the second weld line, is performed by ultrasonic welding. That is, the first weld line and/or the second weld line are/is formed by welding, preferably by ultrasonic welding. According to one embodiment variant, the first weld line and/or the second weld line are/is formed by adhesive bonding or fusion.

According to one embodiment, the first and second assemblies of strips are partially cut, thereby forming non-cut zones allowing the first facemask and the second facemask to be connected. The non-cut zones can be scored by the user in order to detach the first facemask from the second facemask without needing to use a dedicated tool for the cutting.

According to one embodiment, the non-cut zones have dimensions on the micrometer scale, preferably between 10 μm and 500 μm, for example 100 μm.

According to one embodiment, the non-cut zones are evenly spaced from one another.

According to one embodiment, the non-cut zones are located on the first weld line and the second weld line.

According to one embodiment, the non-cut zones are located at the joins between the first weld line or the second weld line and the connecting zones.

According to another embodiment, each of the first and second facemasks is integrally cut out during the cutting step, i.e. the first and second facemasks are not connected to one another.

According to one embodiment, the process moreover comprises a step of winding up the first facemask and the second facemask about an axis in order to form a roll of detachable facemasks.

According to one embodiment, the step of cutting out the first facemask and the second facemask comprises cutting out the contour of the first weld line, cutting out the contour of the second weld line, cutting out the contour of the connecting zones, and cutting out orifices intended to receive the user's ears.

According to one embodiment, the step of cutting out the first facemask and the second facemask is performed such that cutting out the first facemask makes it possible to cut out a part of the adjacent second facemask.

Since the first facemask and the second facemask are formed in a top-to-tail position and next to one another, there is no wastage of material between the first facemask and the second facemask.

According to one embodiment, the first weld line, the second weld line and the orifices intended to receive the user's ears are cut out at the same time. This embodiment is particularly suitable for the formation of a roll of detachable facemasks, since the winding up of the first and the second facemask about an axis makes it possible to maintain the tension in the superposed first and second assemblies of strips and thus repeat the steps rapidly and reliably without creasing or damaging the superposed first and second assemblies of strips.

A certain aspect of the invention relates to the continuous manufacture of a plurality of facemasks.

The term “continuous” is to be interpreted in this document as making it possible to realize a process in which the steps follow on from one another and repeat without interruption and without the need for systematic intervention by an operator between the manufacturing steps.

According to another aspect, the invention provides a facemask comprising:
a first lateral part having a first orifice intended to receive a user's first ear,
a second lateral part having a second orifice intended to receive the users second ear, and
a central part interposed between the first lateral part and the second lateral part, the central part being intended to cover the user's nose and mouth, the central part having a median line, the central part being manufactured from filtering material,
wherein the first lateral part and the second lateral part are each made up of a first zone composed of an elastic material and a second zone composed of a filtering material,
wherein the first zone is located between the central part and the second zone, the second zones respectively defining one lateral end of the facemask,
wherein the first orifice and the second orifice are each located straddling the first zone and the second zone.

By virtue of these features, the first zone and the second zone act in synergy and make it possible both to keep the mask on the users face and to limit the risk of irritation in the area behind the user's ears caused by an elastic material rubbing in the area behind the users ears. By virtue of these features, a portion of the pulling forces which must be exerted in the area behind the users ears is transferred to the first zone. As a result, the facemask is comfortable for the user to wear.

According to one embodiment, the central part has a lower line intended to be positioned below the user's mouth, and an upper line intended to be positioned on the user's nose.

According to one embodiment, the facemask also comprises a semi-rigid nose clip located in the vicinity of the upper line of the central part of the facemask. The nose clip is intended to clip the user's nose in order to keep the mask in the use position. The nose clip is fixed, for example, by sewing or adhesive bonding.

According to one embodiment, the nose clip has the form of a flexible tongue or rod.

According to one embodiment, the nose clip is manufactured from a material selected from: aluminum, plastic or another material of which an angle of curvature can be adjusted by the user by hand.

According to one embodiment, the first zone extends over the entire height of the first lateral part and/or the second lateral part of the facemask.

According to one embodiment, the first zone has a height of between 6 cm and 12 cm, preferably 9 cm.

According to one embodiment, the first zone has a width of between 4 cm and 10 cm, preferably 7 cm.

According to one embodiment, the first zone has a rectangular overall shape out of which a part of the first orifice and/or a part of the second orifice are/is cut.

According to one embodiment, the part of the first orifice and/or the part of the second orifice are/is cut out of the first zone over a width of at least 3 cm and preferably over a width of 5 cm.

According to one embodiment, at least 50%, preferably at least 70%, for example 80%, of the first orifice and/or the second orifice is cut out of the first zone. The rest of the orifice is cut out of the second zone.

According to one embodiment, less than 50%, preferably less than 30%, for example 20%, of the first orifice and/or the second orifice is cut out of the second zone.

According to one embodiment, the first orifice and/or the second orifice are/is cut out of and present solely in the first zone and in the second zone.

According to another aspect of the invention, the invention provides a process for using a facemask obtained above, wherein the facemask is positioned on the user's face so as to cover the user's nose and mouth, the mask being held in position by engaging the user's ears in the orifices intended to receive the ears.

According to one embodiment, the mask is positioned on the face for a duration of less than 10 hours, for example between one hour and five hours, preferably for less than four hours.

The starting point of certain aspects of the invention is the idea of proposing a process which is industiializable on industrial machines in order to meet the need of facemask manufacturers and consumers.

### BRIEF DESCRIPTION OF THE FIGURES

The invention will be understood better, and other aims, details, features and advantages of the invention will become more clearly apparent in the course of the following description of several particular embodiments of the invention, which are given solely by way of non-limiting example and with reference to the appended drawings.

FIG. 1 is a diagram comprising the main steps of the process according to the invention.

FIG. 2 is a functional diagram, seen from above, of the facemask manufacturing process according to one embodiment.

FIG. 3 is an opened-out view of two assemblies of superposed strips according to one embodiment.

FIG. 4 is an opened-out view of two assemblies of superposed strips according to one embodiment.

FIG. 5 is a view of facemasks in a top-to-tail position after the cutting step according to one embodiment.

FIG. 6 is a schematic perspective view of a facemask according to one embodiment.

### DESCRIPTION OF THE EMBODIMENTS

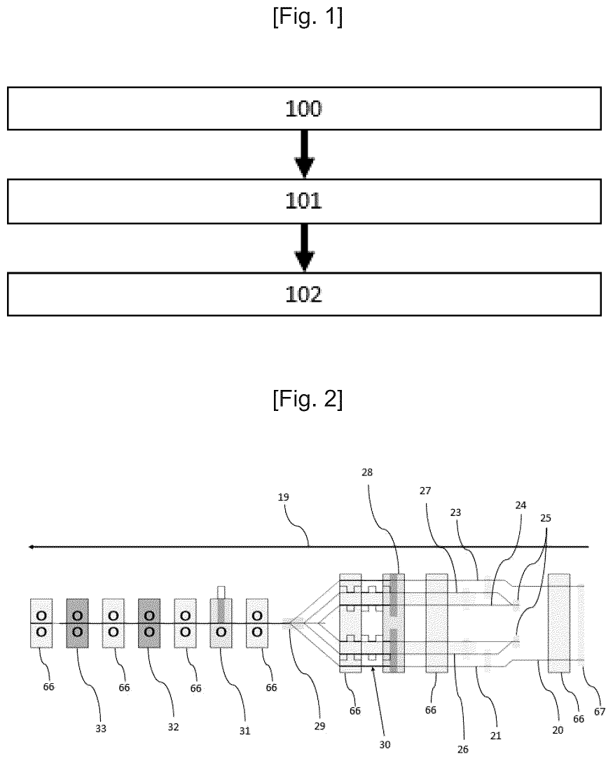

FIG. 1 presents the main steps of the facemask manufacturing process according to the invention. The facemask manufacturing process comprises a first step 100 which consists in providing two assemblies of strips superposed one on the other, a second step 101 which consists in fixing the two assemblies of strips superposed one on the other, and a third step 102 which consists in cutting out the facemasks in a top-to-tail position. The various steps of the facemask manufacturing process will be described in detail below.

FIG. 2 schematically shows the facemask manufacturing process according to one embodiment. The order in which the process is carried out is represented by the arrow 19, and the process is performed from left to right and comprises a succession of multiple steps.

The first step consists in providing a main strip 20 of filtering material that has a longitudinal direction 19. This main strip 20 is, for example, provided via a roll of filtering material. The filtering material is permeable to gases in order to enable the user to breathe properly.

The second step consists in forming superposed first and second assemblies of strips. To do this, knives 25 are used to cut the main strip 20 into three strips 21, 24, 23 of filtering material in order to form the first strip 21 of filtering material, the central strip 24 intended to form the second strip of filtering material and the third strip of filtering material, and the fourth strip 23 of filtering material. The knives 25 are positioned so as to define the width of the strips 21, 24, 23. The first strip 21 of filtering material and the fourth strip 23 of filtering material have identical dimensions and the central strip 24 of filtering material has a width greater than the first strip 21 of filtering material or the fourth strip 23 of filtering material, for example two times greater.

A first elastic strip 26 and a second elastic strip 27 are then positioned between the first strip 21 of filtering material and the central strip 24 of filtering material and between the central strip 24 of filtering material and the fourth strip 23 of filtering material, respectively. The first strip 21 of filtering material and the central strip 24 of filtering material are fixed on either side of the first elastic strip 26. Similarly, the central strip 24 of filtering material and the fourth strip 23 are fixed on either side of the second elastic strip 27. The fixing is preferably performed via ultrasonic welding at a welding zone 28. An assembly of five strips 30 is thus formed.

Moreover, according to one embodiment variant, the first strip 21 of filtering material, the central strip 24 of filtering material and the fourth strip 23 of filtering material comprise a plurality of superposed layers connected to one another by welding at the welding zone 28. This welding preforms a first lateral part and a second lateral part of the first facemask and also a part of the orifices that are intended to receive the ears of the user of the second facemask.

The next step corresponds to a folding step 29 for folding the assembly of five strips along the center of the central strip 24 of filtering material in order to form the second strip of filtering material and the third strip of filtering material, and also the first and the second assembly of three superposed strips (not shown in this figure).

The first assembly of three strips thus formed has a first strip of filtering material corresponding to the strip 21 of filtering material, a second strip of filtering material corresponding to half of the central strip 24 of filtering material, and a first elastic strip corresponding to the elastic strip 26 interposed between the first strip 21 of filtering material and the central strip 24 of filtering material.

The second assembly of three strips thus formed has a third strip of filtering material corresponding to the other half of the central strip 24 of filtering material, a fourth strip of filtering material corresponding to the fourth strip 23 of filtering material, and a second elastic strip corresponding to the second elastic strip 27 interposed between the other half of the central strip 24 of filtering material and the fourth strip 23 of filtering material.

The two superposed assemblies of three strips are then fixed to one another via the fixing step 31 by using, for example, an ultrasonic welding process. This step makes it possible to fix the first strip 21 made of filtering material of the first assembly of strips to the fourth strip 23 made of filtering material of the second assembly of strips along a first weld line, which is described in detail below, and to fix the second strip made of filtering material of the first assembly of strips to the third strip made of filtering material of the second assembly of strips along a second weld line, which is also described in detail below.

Subsequently, a first cutting step 32 is performed using knives in order to form the orifices intended to receive the user's ears, and wastage from cutting out the orifices is removed. Lastly, a second cutting step 33 of cutting out the contour of the facemask is performed in order to form the facemasks. The wastage made up of the rest of the filtering material of the strips of filtering material is removed. The strips are preferably maintained in tension throughout the facemask manufacturing process via strip tensioning units. The strip tensioning units enable the facemask manufacturing process to progress correctly, notably in order to reduce undesired offsets or folding of the main strips 20, the central strip 24 of filtering material, the first strip 21 of filtering material, the fourth strip 23 of filtering material, the assembly of five strips 30 and the two superposed assemblies of three strips during the manufacture of the facemasks. Moreover, during the facemask manufacturing process, the main strip 20, the central strip 24 of filtering material, the first strip 21 of filtering material, the fourth strip 23 of filtering material, the assembly of five strips 30 and then the two superposed assemblies of three strips are preferably guided via a strip guiding device 67. The strip guiding device makes it possible to guide the strips and increase the production rate without reducing the reliability of the facemask manufacturing process.

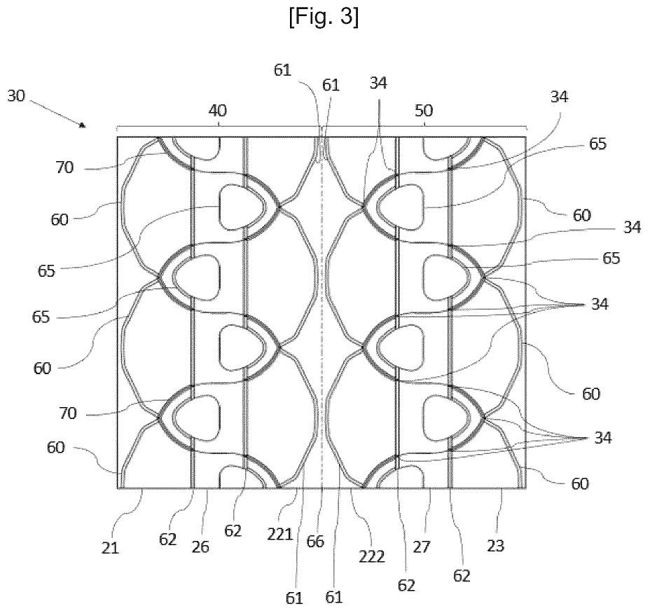

FIG. 3 is a schematic view, opened up along the fold line 66, of a portion of two superposed assemblies of strips 40 and 50 before the second cutting step 33 for cutting out the contour of the facemask according to an embodiment similar to FIG. 2. Although FIG. 3 makes it easier to understand the invention, such an opened-up state does not correspond to a real state of a step of the facemask manufacturing process.

The first assembly of strips 40 is made up of the first strip 21 of filtering material, the first elastic strip 26 and the second strip 221 of filtering material that results from the folding of the central strip 24. The second assembly of strips 50 is made up of the second strip 222 of filtering material that results from the folding of the central strip 24, the second elastic strip 27 and the fourth strip 23 of filtering material. The adjacent strips are fixed to one another by welding, thus forming weld zones 62. In this embodiment, the strips 21, 221, 222, 23 of filtering material comprise a plurality of superposed layers. In this embodiment, a step of connecting said plurality of superposed layers is carried out before the cutting step in order to fix said plurality of superposed layers to one another. This step makes it possible to avoid the plurality of superposed layers being in a dangling state at the end of the step of cutting out the facemask. Specifically, if the superposed layers are in a dangling state, this creates openings and therefore undesirable air passage zones which could reduce the air filtration quality of the facemask. The air could thus pass through the facemask without traversing all of the superposed layers making up the strip of filtering material. This connecting step also forms connecting zones 70 which make it possible to preform the lateral parts of the facemasks and to preform a part of the orifices 65 that are intended to receive the user's ears. According to one embodiment, this connecting step is a welding step, preferably an ultrasonic welding step. As an alternative, this connecting step may also be performed by cold embossing.

Moreover, FIG. 3 illustrates the first weld lines 60 and the second weld lines 61 formed by fixing the first assembly of strips 40 to the second assembly of strips 50, as are produced during step 31 of FIG. 2. These weld lines 60 and 61 are respectively intended to form the median line of the facemask and have a substantially arcuate shape. The shape of the weld lines 60 and 61 can vary in order to best fit the users face.

The preformed adjacent facemasks are in a top-to-tail position and next to one another. This disposition is particularly advantageous in that the cutting step makes it possible to cut out a lateral part of a first facemask and a lateral part of a second facemask adjacent to the first facemask at the same time. As a result, the facemask manufacturing process is efficient and makes it possible to produce large numbers of facemasks while still reducing the losses of material.

According to an advantageous variant presented in FIG. 3, the cutting step 33 for cutting the two assemblies of three strips is partial, thus forming scorable non-cut zones 34 and making it possible to connect adjacent facemasks. The non-cut zones 34 are preferably located in the weld zones 62 and notably at the junctions between the weld lines 60, 61 and connecting zones 70. The non-cut zones 34 are particularly advantageous in that they make it possible to provide a connection between the adjacent facemasks, making it easier to package them. This makes it possible for example to produce a roll of detachable facemasks or a batch of detachable facemasks.

FIG. 3 illustrates the manufacture of four facemasks. One embodiment also provides the manufacture of a significant number of facemasks, for example between two and one thousand facemasks, for example 50 or 100 facemasks. For this, it is necessary to adapt the length of the first assembly of strips 40 and the second assembly of strips 50.

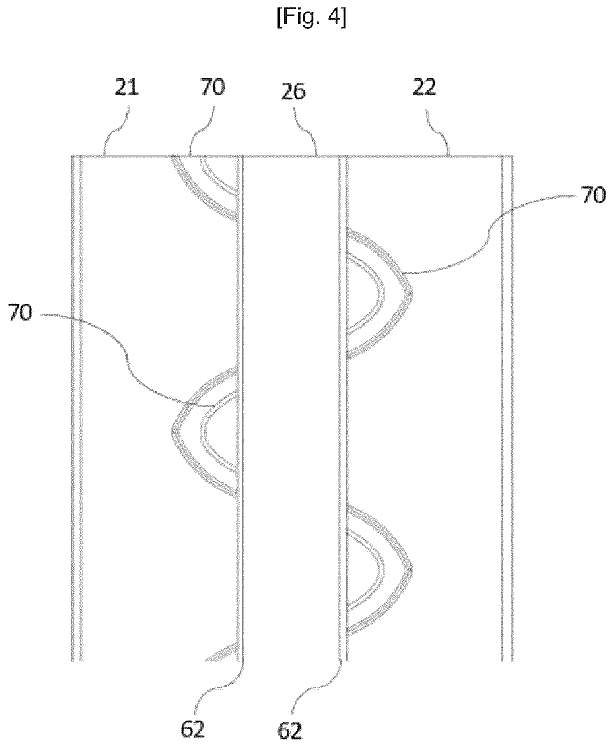

FIG. 4 presents another embodiment and illustrates an assembly of strips. The assembly of strips is produced via welding a first strip 21 of filtering material and a second strip 22 of filtering material on either side of an elastic strip 26, thus forming two weld zones 62. The first strip 21 of filtering material and the second strip 22 of filtering material each comprise a plurality of superposed layers. As a result, similarly to the embodiment presented in FIG. 3, a connecting step is performed in order to connect the superposed layers. The connecting step is, for example, performed by ultrasonic welding and makes it possible to preform a part of the facemask on the strips 21 and 22 of filtering material via the connecting zones 70. The facemask manufacturing process according to one embodiment is carried out by providing two assemblies of three strips superposed one on the other.

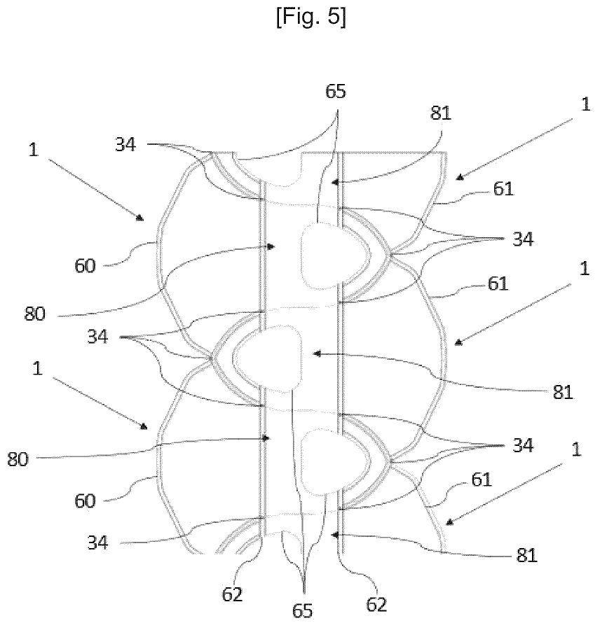

FIG. 5 shows a plurality of adjacent facemasks 1 in a top-to-tail position, which are connected to one another via non-cut zones 34. The non-cut zones can be easily detached by a user and do not reduce the effectiveness of the facemask 1 in terms of its use. In a similar way to FIG. 3, the non-cut zones 34 are located in the weld zones 62 and at the junctions between the weld lines 60, 61 and connecting zones 70.

The facemask 1 thus obtained has two lateral parts 80 and 81, just one of which is visible on each facemask in FIG. 5. The two lateral parts 80 and 81 each comprise an orifice 65, which have, for example, a triangular shape with rounded vertices and are intended to receive the user's ears.

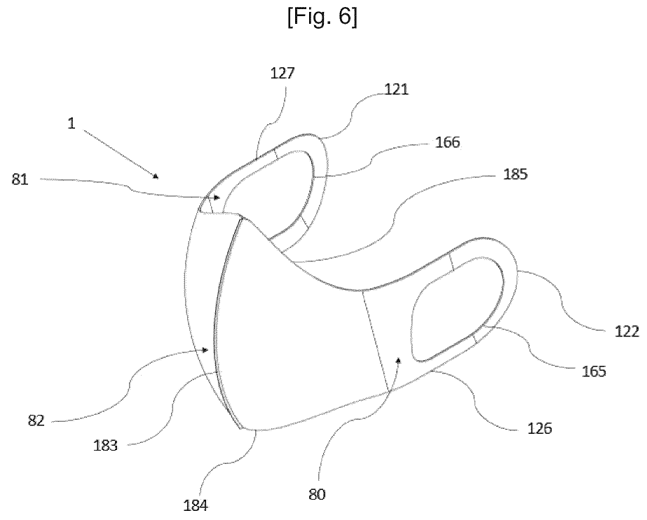

FIG. 6 describes a facemask 1 according to one embodiment. In a similar way to FIG. 5, the facemask 1 has a first lateral part 80 comprising a first orifice 165 and a second lateral part 81 comprising a second orifice 166. The orifices 165 and 166 have a rectangular shape with rounded edges. The shape of the orifices can also be round, oval, polygonal or another shape that makes it possible to hold the facemask comfortably on the users ear. The facemask 1 comprises a central part 82 located between said lateral parts 80 and 81. The central part has a median line 183. The median line 183 is formed by the first weld line 60 or the second weld line 61 that are formed by the fixing described notably in step 31 of FIG. 2. Moreover, the central part has a lower line 184 intended to be positioned below the users mouth, notably below the chin, and an upper line 185 intended to be positioned on the user's nose and below their eyes. The first lateral part 80 is made up of a first elastic zone 126 provided from an elastic strip of the facemask manufacturing process and a second zone 122 composed of a filtering material provided from a strip of filtering material of the process. In a similar way to the first lateral part 80, the second lateral part 81 is made up of a first elastic zone 127 provided from another elastic strip of the process and a second zone 121 composed of a filtering material provided from another strip of filtering material of the process. The first and second orifices 165 and 166 are located straddling the first zone 126 and 127 and the second zone 122 and 121, respectively.

The first elastic zone 126 of the first lateral part 80 or the first elastic zone 127 of the second lateral part 81 has a height of approximately 9 cm and a width of approximately 7 cm.

The first elastic zones 126 and 127 have a rectangular overall shape before cutting, in which a part of the orifices 165 and 166 is formed.

In one embodiment, 60% of the orifice 165 or 166 is cut out of the first elastic zone 126 or 127 and 40% of the orifice 165 or 166 is cut out of the second zone 121 or 122.

The dimensions of the facemask can be modified in order to adapt them to the dimensions of the users head, for example if the user is a child, an adolescent or an adult.

Although the invention has been described in connection with several particular embodiments, it is clear that it is in no way limited thereto and that it comprises all the technical equivalents of the means described and combinations thereof, provided they fall within the scope of the invention.

The use of the verb “have”, “comprise” or “include” and conjugated forms thereof does not rule out the presence of elements or steps different to those stated in a claim.

In the claims, any reference sign between parentheses should not be interpreted as limiting the claim.

1. A facemask manufacturing process comprising:
providing a first and a second assembly of strips superposed one on the other, the first assembly of strips (40) comprising a first strip (21) of filtering material, a second strip (22, 221) of filtering material and a first elastic strip (26) interposed between the first strip (21) of filtering material and the second strip (22, 221) of filtering material; the second assembly of strips (50) comprising a third strip (222) of filtering material, a fourth strip (23) of filtering material and a second elastic strip (27) interposed between the third strip (222) of filtering material and the fourth strip (23) of filtering material, the first strip (21) of filtering material, the second strip (22, 221) of filtering material and the first elastic strip (26) being superposed on the fourth strip (23) of filtering material, the third strip (222) of filtering material and the second elastic strip (27), respectively; then
fixing the first strip (21) of filtering material to the fourth strip (23) of filtering material along a first weld line (60);
fixing the second strip (22, 221) of filtering material to the third strip (222) of filtering material along a second weld line (61); and then
a step of cutting the first and second assemblies of strips in order to form, in a top-to-tail position, a first facemask and a second facemask respectively having a median line (183) corresponding to the first weld line (60) and to the second weld line (61) and orifices (65, 165, 166) intended for receiving the user's ears.

2. The facemask manufacturing process as claimed in claim 1, wherein the first and the second assembly of strips superposed one on the other are formed from an assembly of five strips (30) comprising the first strip (21) of filtering material, a central strip (24) of filtering material that is intended to form the second strip (22, 221) of filtering material and the third strip (222) of filtering material, the fourth strip (23) of filtering material, the first elastic strip (26) interposed between the first strip (21) of filtering material and the central strip (24) of filtering material, and the second elastic strip (27) interposed between the fourth strip (23) of filtering material and the central strip (24) of filtering material, wherein the assembly of five strips (30) is folded along the center (66) of the central strip (24) of filtering material in order to form said second strip (22, 221) of filtering material and said third strip (222) of filtering material and also the superposed first assembly (40) of strips and second assembly (50) of strips.

3. The facemask manufacturing process as claimed in claim 2, wherein the central strip (24) of filtering material has a width at least twice that of the first strip (21) of filtering material.

4. The facemask manufacturing process as claimed in claim 1, wherein the first and the second assembly of strips superposed one on the other are formed from two separate assemblies of strips, the first assembly of strips being respectively formed from the first strip (21) of filtering material, the second strip (22) of filtering material, and the first elastic strip (26) interposed between the first strip (21) of filtering material and the second strip (22) of filtering material, wherein the first strip (21) of filtering material and the second strip (22) of filtering material are fixed on either side of the first elastic strip (26) in order to form said first assembly of strips, and the second assembly of strips being respectively formed from the third strip (222) of filtering material, the fourth strip (23) of filtering material, and the second elastic strip (27) interposed between the third strip (222) of filtering material and the fourth strip (23) of filtering material, wherein the third strip (222) of filtering material and the fourth strip (23) of filtering material are fixed on either side of the second elastic strip (27) in order to form said second assembly of strips.

5. The facemask manufacturing process as claimed in claim 1, wherein at least one strip selected from the first strip (21) of filtering material, the second strip (22, 221) of filtering material, the third strip (222) of filtering material and the fourth strip (23) of filtering material has at least two superposed layers, preferably three superposed layers.

6. The facemask manufacturing process as claimed in claim 5, wherein a connecting step is performed upstream of the cutting of the first and second assemblies of strips in order to fix the at least two superposed layers to one another and to preform, via the connecting zones (70), both a first lateral part and a second lateral part of the first facemask and part of the orifices (65) of the second facemask that are intended to receive the user's ears.

7. The facemask manufacturing process as claimed in claim 1, wherein the first elastic strip (26) and the second elastic strip (27) have an identical width.

8. The facemask manufacturing process as claimed in claim 1, wherein the first elastic strip (26) and the second elastic strip (27) comprise an elastomer material.

9. The facemask manufacturing process as claimed in claim 1, wherein a roll of filtering material provides a main strip (20) of filtering material having a longitudinal direction, and wherein the first strip (21) of filtering material, the central strip (24) of filtering material and the fourth strip (23) of filtering material are cut out of the main strip (20) of filtering material via a step of cutting along the longitudinal direction of the main strip (20) of filtering material.

10. The facemask manufacturing process as claimed in claim 1, wherein a roll of elastic material provides a main strip of elastic material having a longitudinal direction, and wherein the first elastic strip (26) and the second elastic strip (27) are cut out of the main strip of elastic material via a step of cutting along the longitudinal direction of said main strip of elastic material.

11. The facemask manufacturing process as claimed in claim 1, wherein the fixing of the first strip (21) of filtering material to the fourth strip (23) of filtering material along the first weld line (60), and/or the fixing of the second strip (22, 221) of filtering material to the third strip (222) of filtering material along the second weld line (61), is performed by ultrasonic welding.

12. The facemask manufacturing process as claimed in claim 1, wherein the first and second assemblies of strips are partially cut, thereby forming non-cut zones (34) allowing the first facemask and the second facemask to be connected.

13. The facemask manufacturing process as claimed in claim 12, wherein the non-cut zones (34) are located on the first weld line (60) and the second weld line (61).

14. The facemask manufacturing process as claimed in claim 12, wherein the non-cut zones (34) are located at the joins between the first weld line (60) or the second weld line (61) and the connecting zones (70).

15. The facemask manufacturing process as claimed in claim 12, the process moreover comprising a step of winding up the first facemask and the second facemask about an axis in order to form a roll of detachable facemasks.

16. A facemask comprising:
a first lateral part (80) having a first orifice (165) intended to receive a user's first ear,
a second lateral part (81) having a second orifice (166) intended to receive the user's second ear, and
a central part (82) interposed between the first lateral part (165) and the second lateral part (166), the central part (82) being intended to cover the user's nose and mouth, the central part (82) having a median line (183), the central part (82) being manufactured from filtering material,
wherein the first lateral part (80) and the second lateral part (81) are each made up of a first zone (126, 127) provided from a strip composed of an elastic material and a second zone (121, 122) provided from a strip composed of a filtering material, wherein the first zone (126, 127) is located between the central part (82) and the second zone (121, 122), the second zones (121, 122) respectively defining one lateral end of the facemask (1),
wherein the first orifice (165) and the second orifice (166) are each cut out of the first zone and the second zone and located straddling the first zone (126, 127) and the second zone (122, 121).
